(19) United States
(12) Patent Application Publication
(10) Pub. No.: US 2026/0024074 A1
(43) Pub. Date: Jan. 22, 2026

(54) Method for Communicating with Fingerprint Card to Perform Transaction and Fingerprint Card

(71) Applicant: FEITIAN TECHNOLOGIES CO., LTD., BEIJING (CN)

(72) Inventors: Zhou Lu, Beijing (CN); Huazhang Yu, Beijing (CN)

(21) Appl. No.: 19/275,630

(22) Filed: Jul. 21, 2025

Related U.S. Application Data
(63) Continuation-in-part of application No. 17/909,434, filed on Sep. 5, 2022.

(30) Foreign Application Priority Data
Nov. 26, 2020 (CN) 202011342326.4

(51) Int. Cl. G06Q 20/34; G06Q 20/40

(52) U.S. Cl. CPC G06Q 20/341; G06Q 20/3437; G06Q 20/40145

(57) ABSTRACT

A method for communicating with a fingerprint card to perform transaction, comprising the following steps: receiving a Processing Options Data Object List (PDOL) request from a terminal, sending a waiting time extending instruction at a preset interval, obtaining and verifying a user's fingerprint, determining a specific transaction type from the PDOL request, matching the terminal type, ensuring the transaction is not refused by an application controller, and returning a response with an Application Interchange Profile (AIP) and Application File Locator (AFL) to the terminal. It also involves returning a read record based on the AFL. According to the present invention, a process of using the fingerprint card includes an additional step of verifying the fingerprint. Once the fingerprint verification is successful, there is no need to enter a password or sign anymore. This solves the problem of being unable to use any smart card due to forgetting its password.

### CROSS-REFERENCE TO RELATED APPLICATIONS

This application is a continuation-in-part (CIP) application. with the US filing date of Sept. 5, 2022 under § 317(c)(1) (2). and based on U.S. application Ser. No. US17/909.434, and titled “Fingerprint Card Implementation Method and Fingerprint Card”.

### FIELD OF THE INVENTION

The present invention is related to a method for realizing a fingerprint card and the fingerprint card itself. which belongs to communication technology field.

### PRIOR ART

At present, when performing transaction communication by using an IC card, verifying identity of a card holder is performed according to application controller returned by the IC card, for example, verifying PIN code usually. When a PIN code is inputting by the card holder, the PIN code is easily to be leaked because of peeping at PIN code or the PIN code is intercepted by a terminal, therefore security risk of information of card holder is coming up. In addition, when a card holder has many IC cards, the card cannot be used normally because the card holder forgets PIN code or mistaken memory of the card holder.

Especially, in the prior art, although there are various authentication methods such as a PIN verification and a fingerprint verification, when using an IC card for transaction communication, the authentication information is always received and verified by a terminal device itself. No one has ever considered to separate a reception of authentication information and an authentication thereof from the terminal device, thereby preventing from any leakage of PIN codes or other sensitive information entered on the terminal device, which easily occurs due to network attack or terminal hijacking.

### SUMMARY OF THE INVENTION

The object of the present invention is to provide a method for communicating with a fingerprint card to perform transaction and a fingerprint card, which can enhance security of the fingerprint card. In a process of using the card, a verifying fingerprint is added and, and inputting a password or a signature is no longer needed after the verifying fingerprint successfully, which solves such a problem that a card cannot be used due to forgetting password.

Thus, according to a first aspect of the present invention, there is provided a method for communicating with a fingerprint card to perform transaction, which comprises the following steps:
receiving, by the fingerprint card, an instruction comprising a Processing Options Data Object List request from a terminal;
sending, by the fingerprint card, to the terminal a waiting time extending instruction at a preset time interval;
obtaining, by the fingerprint card, a fingerprint of a user;
verifying, by the fingerprint card, the fingerprint of the user;
obtaining, by the fingerprint card, a fingerprint verifying result;
obtaining, by the fingerprint card, a specific transaction type in the Processing Options Data Object List request;
determining, by the fingerprint card, that a terminal type of the terminal matches a specific terminal type;
determining, by an application controller in the fingerprint card, that a transaction with the specific transaction type is not refused;
returning, by the fingerprint card, to the terminal a response comprising an Application Interchange Profile and an Application File Locator; and
returning, by the fingerprint card, to the terminal a read record according to the Application File Locator.

According to a second aspect of the present invention, there is provided a fingerprint card, which comprises: a processor; an input/output device coupled to the processor; and a memory in communication with the processor, in which the memory stores instructions configured to cause the processor to execute the method for communicating with a fingerprint card to perform transaction according to the present invention.

According to a third aspect of the present invention, there is provided a method for realizing fingerprint card, which comprises the following steps:
Step 1, receiving, by a card, an instruction sent by a terminal, and determining type of the instruction: when the instruction is a third instruction comprising Processing Options Data Object List data, executing Step 2;
Step 2, determining, by the card, value of application controller attribution of the card,
when the value of the application controller attribution of the card is a first preset value, verifying, by the card, fingerprint of a user, obtaining a result of fingerprint verifying and determining whether the result of fingerprint verifying is that fingerprint verifying is successful, if yes, executing Step 3, if no, setting, by the card, a transaction refusing flag, executing Step 4;
when the value of the application controller attribution is a second preset value, verifying, by the card, fingerprint of the user, obtaining a fingerprint verifying result and determining whether the fingerprint verifying result is that fingerprint verifying is successful, if yes, executing Step 3; otherwise, executing Step 4; and
when value of the application controller attribution is a third preset value, determining, by the card, whether type of the terminal is a specified terminal type, if yes, executing Step 4; if no, verifying, by the card, fingerprint of the user, obtaining a fingerprint verifying result and determining whether the fingerprint verifying result is that fingerprint verifying is successful, if yes, executing Step 3, if no, setting, by the card, a transaction refusing flag, then executing Step 4;
Step 3, determining, by the card, whether transaction type in the Processing Options Data Object List data is specified type of transaction, if yes, executing Step 4; if no, executing Step 5;
Step 4, returning, by the card, a third instruction response of default type comprising a first Application Interchange Profile and a first application file locator to the terminal;
Step 5, returning, by the card, a third instruction response of fingerprint type comprising a second Application Interchange Profile and a second application file locator to the terminal;
when the instruction is a fourth instruction generated according to a first application file locator, returning, by the card, a read record specified by the first application file locator to the terminal; and when the instruction is a fourth instruction generated according to a second application file locator, returning, by the card, a read record specified by the second application file locator to the terminal.

According to a fourth aspect of the present invention, there is provided a fingerprint card. which comprises:
a receiving module configured to receive an instruction sent from a terminal;
a first determining module configured to determine type of the instruction received by the receiving module;
a second determining module configured to determine value of application controller attribution of the card when the first determining module determines that type of the instruction; when the instruction is a third instruction comprising Processing Options Data Object List data;
a verifying and obtaining and determining module configured to verify fingerprint of a user, obtain a fingerprint verifying result and determine whether the fingerprint verifying result is that fingerprint verifying is successful when the second determining module determines that the value of application controller attribution of the card is a first preset value;
the verifying and obtaining and determining module further configured to verify fingerprint of a user, obtain a fingerprint verifying result and determine whether the fingerprint verifying result is that fingerprint verifying is successful when the second determining module determines that the value of application controller attribution of the card is a second preset value;
the verifying and obtaining and determining module further configured to verify fingerprint of a user, obtain a fingerprint verifying result and determine whether the fingerprint verifying result is that fingerprint verifying is successful when a third determining module determines that type of the terminal is a specified terminal type;
the third determining module configured to determine whether type of the terminal is a specified terminal type when the second determining module determines that the value of the application controller attribution is a third preset value;
a setting module configured to set transaction refusing flag when the second determining module determines that the value of the application controller attribution is the first preset value and the verifying and obtaining and determining module determines that the fingerprint verifying result is not that fingerprint verifying is successful;
the setting module further configured to set transaction refusing flag when the third determining module determines that the type of the terminal is not a specified terminal type and the verifying and obtaining and determining module determines that the fingerprint verifying result is not that fingerprint verifying is successful;
a fourth determining module configured to determine whether transaction type in the Processing Options Data Object List data is specified type of transaction when the verifying and obtaining and determining module determines that the fingerprint verifying result is that fingerprint verifying is successful;
a first returning module configured to, after the setting module sets the transaction refusing flag. return a third instruction response of default type comprising a first Application Interchange Profile and a first application file locator to the terminal;
the first returning module further configured to, when the fourth determining module determines that transaction type in the Processing Options Data Object List data is a specified type of transaction, return a third instruction response of fingerprint type comprising a second Application Interchange Profile and a second application file locator to the terminal;
the first returning module further configured to return a third instruction response of default type comprising a first Application Interchange Profile and a first application file locator to the terminal when the second determining module determines that the value of application controller attribution of the card is a second preset value and the verifying and obtaining and determining module determines that the fingerprint verifying result is not that fingerprint verifying is successful;
the first returning module further configured to return a reading record specified by the first application file locator to the terminal when the first determining module determines that the type of the instruction is a fourth instruction generated according to a first application file locator; and
a second returning module configured to return a third instruction response of fingerprint type comprising a second Application Interchange Profile and a second application file locator to the terminal when the fourth determining module determines that the transaction type in the Processing Options Data Object List data is not specified transaction type; further configured to return a reading record specified by the second application file locator to the terminal when the first determining module determines that the type of the instruction is a fourth instruction generated according to the second application file locator.

According to the present invention, a fingerprint identifying module is added to the IC card, and fingerprint verifying is added during a process of using the card, inputting an online PIN code or a signature is no longer needed after the fingerprint is verified successfully. In this way, any PIN code is not leaked easily, and any problem that card cannot be used due to forgetting password is avoided.

According to the present invention, as a convenient alternative to the PIN code, the claimed solution achieves a more efficient and convenient authentication experience, while maintaining the original level of security. Moreover, even if the PIN is not remembered, a convenient verification can still be performed.

### BRIEF DESCRIPTION OF DRAWINGS

FIGS. 1-1, 1-2, and 1-3 are a flow chart for a method for communicating with a fingerprint card to perform transaction according to the present invention:

FIG. 2 is a flow chart for another method for communicating with the fingerprint card to perform transaction according to the present invention:

FIG. 3 is a block diagram of the fingerprint card according to the present invention: and

FIG. 4 is a flow chart depicting a method for communicating with the fingerprint card to perform transaction according to the present invention.

### BEST MODE FOR CARRYING OUT THE INVENTION

In the following, clear and complete description will be made on technical solutions in embodiments of the present disclosure in connection with the drawings of the embodiments of the present disclosure. Obviously, the described embodiments are only part of embodiments of the present disclosure, but not all the embodiments. All other embodiments obtained by those skilled in the art based on the embodiments in the present disclosure without creative work fall in the protection scope of the present disclosure.

### IC Card

The term “IC card” refers to a portable device that includes one or more integrated circuit chips and stores information that can be used in conjunction with payment transactions (e.g., payment information, personal information, biometric information, etc.). According to some embodiments, the IC card can be a contact or contactless device capable of transaction communication with a reader device using wireless communication technology. According to some embodiments, the IC card is adapted to exchange data with an external computer device and includes a card body, an IC chip, a fingerprint scanner, and a control unit. The IC chip is located on the surface of the card body and is used to store the owner's fingerprint data. The fingerprint scanner is also located on the surface of the card body.

### Logic for Cardholder Verification of a Fingerprint Card (an IC Card Used for Payment Transaction Communications and Storing Authentication Information)

Based on one of the following rules stored in the fingerprint card, the application controller within the fingerprint card decides whether to reject or not reject the transaction:
for any terminal, if a fingerprint verification result is unsuccessful, the transaction is rejected;
For terminals of a specific terminal type, if a fingerprint verification result is unsuccessful, the transaction is not rejected; and
For any terminal that is not of the specific terminal type, if a fingerprint verification result is unsuccessful, the transaction is rejected.

### Application Controller

The application controller of an IC card is an integrated circuit module within the IC card that is responsible for processing and managing various application logics of the IC card. It typically includes a microprocessor (CPU). memory (such as EEPROM, RAM, ROM, etc.), and related control logic. The application controller is the core component of the IC card, enabling it to perform various complex operations, such as data storage, encryption processing, and user authentication.

The application controller of an IC card is referred to as “Application Controller” or “Card Controller”. These two terms may vary slightly in different contexts, but both refer to the component within the IC card that is responsible for managing and controlling various application functions.

“Application Controller” is a general term used to describe any component that is responsible for managing and controlling application logic. In the context of IC cards, it specifically refers to the microprocessor and related control logic within the IC card that handle and manage various application functions of the IC card.

“Card Controller” is a more specific term. usually used to describe the hardware component within the IC card that is responsible for controlling the basic operations and communications of the IC card. It may include a microprocessor, memory, and other control logic circuits.

### Processing Options Data Object List (PODOL)

In IC card technology, the “Processing Options Data Object List” (PODOL) is used to describe the various options and parameters that an IC card can utilize when processing a transaction or performing a specific operation. This list is typically stored in the file system of the IC card and is used to guide the behavior of the IC card in specific scenarios.

### Definition

Processing Options Data Object List (PODOL): A list containing multiple data objects that define the various options and parameters available to an IC card when processing a transaction or performing a specific operation. These options and parameters may include transaction type, security settings, encryption algorithms, application selection, etc.

### Components

Data Objects: Each data object contains specific information, such as transaction amount, transaction type, security parameters, etc. Data objects are typically structured as tag-value pairs, where the tag identifies the type of data, and the value represents the actual data content.

### List Structure

Data objects are organized in a list format, with each data object being independently accessible and processable. The structure of the list can be linear or hierarchical, depending on the application requirements.

### Functions

Transaction Processing: In payment transactions, PODOL can define transaction types (e.g., purchase, refund, pre-authorization), transaction amounts, encryption algorithms, etc. For example, one data object might specify a transaction amount of 100 yuan, while another might specify the use of the AES encryption algorithm.

Application Selection: In multi-application IC cards, PODOL can define which applications can be selected and used. For example, one data object might specify that the currently selected application is the transportation card application, while another might specify the payment card application.

Security Settings: PODOL can define security-related parameters, such as key versions and authentication methods. For example, one data object might specify fingerprint authentication, while another might specify PIN code authentication.

Configuration Management: PODOL can define configuration parameters for the IC card, such as default language and default transaction currency. For example, one data object might specify the default language as Chinese, while another might specify the default transaction currency as the Chinese yuan.

### Application Scenarios

Payment Systems: In credit card and debit card transactions, PODOL is used to define specific transaction parameters, such as transaction amount, transaction type, encryption algorithm, etc. For example, a payment terminal reads the data objects in the PODOL of an IC card to determine the specific requirements of the transaction.

Transportation Card Systems: In public transportation cards (e.g., bus cards, subway cards), PODOL is used to define the usage rules of the transportation card, such as fare amount and number of rides. For example, a subway gate reads the data objects in the PODOL of a transportation card to determine the fare amount and number of rides.

Access Control Systems: In access control cards, PODOL is used to define the permission settings of the access control card, such as access areas and access times. For example, an access control system reads the data objects in the PODOL of an access control card to determine whether the user has permission to enter a specific area.

### EXAMPLE

The following is a simple example of a PODOL, assuming it is a transaction processing options data object list for a payment card:

### Processing Options Data Object List:

1. Tag: 0x80, Value: 0x01 (Transaction Type: Purchase)
2. Tag: 0x81, Value: 0x64 (Transaction Amount: 100)
3. Tag: 0x82, Value: 0x01 (Encryption Algorithm: AES)
4. Tag: 0x83, Value: 0x01 (Authentication Method: PIN)

### In This Example:

Data Object 1 (Tag: 0x80, Value: 0x01) indicates that the transaction type is a purchase.
Data Object 2 (Tag: 0x81, Value: 0x64) indicates that the transaction amount is 100 yuan.
Data Object 3 (Tag: 0x82, Value: 0x01) indicates the use of the AES encryption algorithm.
Data Object 4 (Tag: 0x83, Value: 0x01) indicates the use of PIN code authentication.

### Technical Implementation

In IC card systems, the PODOL is typically stored in the file system of the IC card and can be accessed and read through specific commands (such as the SELECT command). For example, in the ISO 7816 standard, the PODOL can be interacted with through APDU (Application Protocol Data Unit) commands.

### Summary

The “Processing Options Data Object List” (PODOL) is an important concept in IC card technology. It defines the various options and parameters available to an IC card when processing a transaction or performing a specific operation through a series of data objects. PODOL is widely used in various application scenarios, including payment systems, transportation card systems, and access control systems, ensuring the flexibility and security of IC card operations.

### Application File Locator (AFL) of an IC Card

The Application File Locator (AFL) is an important component in a file system of an IC card, used to indicate a location of application-related files and a range of records. It helps terminal devices (such as POS machines, card readers, etc.) quickly locate and read data files related to specific applications on the IC card.

### Functions

File Location: The AFL provides specific location information for application-related files and records. It identifies particular files and records through Short File Identifiers (SFI) and record numbers. Each AFL entry specifies the initial and final record numbers to be read from a file, as well as which records are to be used in offline data authentication.

Optimizing the Reading Process: The AFL helps terminal devices optimize the reading process, reducing unnecessary data transmission and improving transaction processing efficiency. Terminal devices use the READ RECORD command to request the specified records based on the information in the AFL.

Support for Offline Data Authentication: The AFL also supports the Offline Data Authentication (ODA) process, ensuring the security of transactions.

### Structure

The AFL typically contains multiple entries, each corresponding to a file or range of records. Each entry may include the following information:

Short File Identifier (SFI): A symbol used to uniquely identify application-defined files.

Record Range: Specifies the starting and ending record numbers to be read.

### Application Scenarios

Payment Systems: In credit card and debit card transactions, the AFL is used to locate and read data files related to the transaction, such as account balances and transaction records. Terminal devices quickly obtain the necessary data through the AFL to complete transaction processing.

Public Transportation Systems: In transportation cards such as bus cards and subway cards, the AFL is used to locate and read data files related to ride records and balances. Terminal devices (such as turnstiles) quickly read the necessary data through the AFL to complete fare deduction or recharge operations.

### Example

Assuming an IC card stores data files for multiple applications, the AFL might look like this:

### AFL Entry 1:

SFI: 0x01
Record Range: 1-5

### AFL Entry 2:

SFI: 0x02
Record Range: 1-3

In this example, the terminal device will use the READ RECORD command to read records 1 to 5 from the file with SFI 0x01 and records 1 to 3 from the file with SFI 0x02, based on the information in the AFL.

### Summary

The Application File Locator (AFL) is a key component in the IC card file system. By providing specific location information for files and records, it helps terminal devices quickly locate and read data files related to specific applications. The AFL not only optimizes the reading process and improves transaction processing efficiency but also supports offline data authentication to ensure the security of transactions.

### Application Interchange Profile (AIP)

The AIP is an important data element in smart card technology, returned by the card in response to the GPO (Get Processing Options) command. The AIP indicates the card's support for various functions, which include but are not limited to:
Static Data Authentication (SDA): Used to verify the integrity and authenticity of card data.
Dynamic Data Authentication (DDA): Provides enhanced security compared to SDA, verifying the card through dynamically generated authentication data.
Combined Data Authentication (CDA): Combines DDA with other security mechanisms to further enhance transaction security.
Cardholder Verification: Supports cardholder authentication methods such as PIN verification.
Terminal Risk Management: Allows the terminal to conduct risk assessments based on information provided by the card.
Issuer Authentication: Supports additional authentication of transactions by the card issuer.

### Format and Length

The length of the AIP is fixed at 2 bytes. Each bit of the bytes has a specific meaning, used to identify particular functions supported by the card. For example, bit 7 of the AIP indicates whether SDA is supported, bit 6 indicates whether DDA is supported, and so on.

### Function

The AIP plays a crucial role in transaction processing. It helps terminal devices understand the card's capabilities, thereby correctly handling transaction requests. For example, the terminal can decide whether online authorization is needed and whether specific cardholder verification methods are supported based on the value of the AIP.

### Format

The AIP is typically returned together with the AFL (Application File Locator). The AFL contains the SFI (Short File Identifier) and record range of the card data files that the terminal will read for transaction processing.

### Example

Here is an example of an AIP and its meaning:
AIP: 7D 00
7D: Indicates support for SDA, DDA, cardholder verification, terminal risk management, issuer authentication, and combined DDA/AC generation.
00: Reserved bits for future expansion.

Through the AIP, the smart card can effectively interact with terminal devices, ensuring the security and correctness of transactions.

### EMBODIMENT

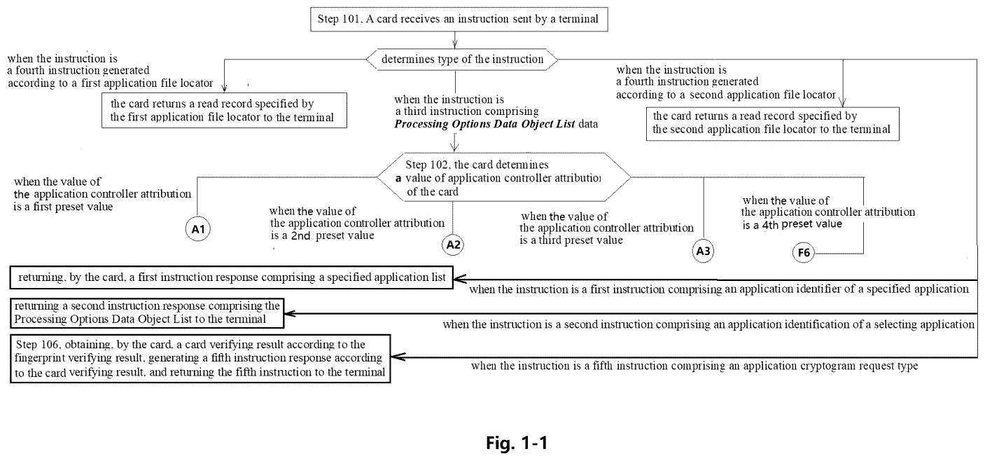

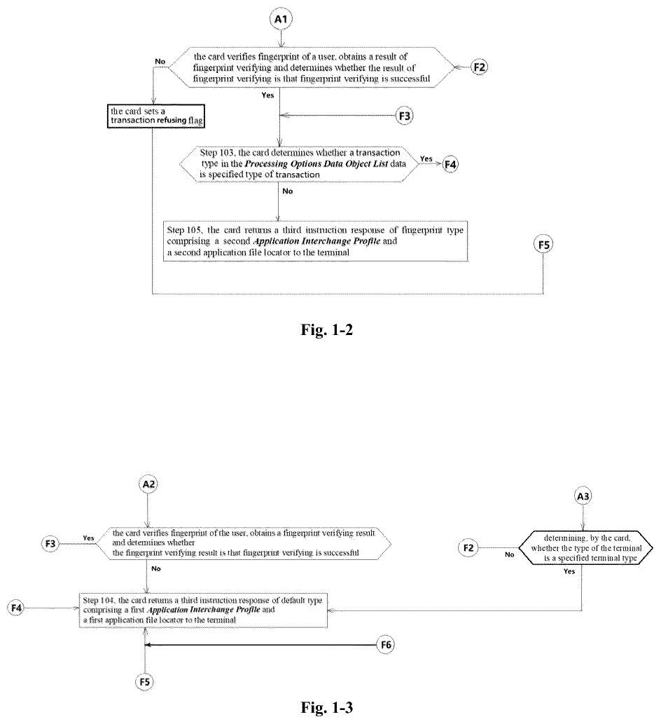

The implementation method of the fingerprint card (hereinafter referred to as the “card”) according to the present invention, as shown in FIGS. 1-1, 1-2, and 1-3, specifically includes:

Step 101, A card receives an instruction sent by a terminal and determines type of the instruction, when the instruction is a third instruction comprising Processing Options Data Object List data, executing Step 102.

Step 102, the card determines value of application controller attribution of the card;
when the value of application controller attribution of the card is a first preset value, the card verifies fingerprint of a user, obtains a result of fingerprint verifying and determines whether the result of fingerprint verifying is that fingerprint verifying is successful, if yes, executes Step 103, if no, the card sets a transaction refusing flag, then executes Step 104;
when the value of the application controller attribution is a second preset value, the card verifies fingerprint of the user, obtains a fingerprint verifying result and determines whether the fingerprint verifying result is that fingerprint verifying is successful, if yes, executing Step 103; otherwise, executing Step 104;
when the value of the application controller attribution is a third preset value, the card determines whether type of the terminal is a specified terminal type, if yes, executing Step 104; if no, the card verifies fingerprint of the user, obtains a fingerprint verifying result and determines whether the fingerprint verifying result is that fingerprint verifying is successful, if yes, executing Step 103, if no, setting, by the card, a transaction refusing flag, then executing Step 104;

Step 103, the card determines whether transaction type in the Processing Options Data Object List data is specified type of transaction, if yes, executing Step 104; if no, executing Step 105.

Step 104, the card returns a third instruction response of default type comprising a first Application Interchange Profile and a first application file locator to the terminal.

Step 105, the card returns a third instruction response of fingerprint type comprising a second Application Interchange Profile and a second application file locator to the terminal;
when the instruction is a fourth instruction generated according to a first application file locator, the card returns a read record specified by the first application file locator to the terminal;
when the instruction is a fourth instruction generated according to a second application file locator, the card returns a read record specified by the second application file locator to the terminal.
that the value of application controller attribution of the card is a first preset value specifically is that the application controller attribution is: for any terminal, refuse transaction if fingerprint verifying is not successful;
that the value of application controller attribution of the card is a second preset value specifically is that the application controller attribution is: do not refuse transaction if the fingerprint verifying is not successful;

that the value of application controller attribution of the card is a third preset value specifically is that the application controller attribution is: for any terminal which is not a specified terminal, refuse transaction if the fingerprint is not successful.

Step 102 further comprising: when value of the application controller attribution of the card is a fourth preset value, executing Step 104.

that value of the application controller attribution of the card is a fourth preset value specifically is that application controller attribution is: do not supporting fingerprint verifying.

Step 101 further comprises: when the instruction is a fifth instruction comprising an application cryptogram request type, executing Step 106;

Step 106, the card obtains a card verifying result according to the fingerprint verifying result, generates a fifth instruction response according to the card verifying result, and returns the fifth instruction to the terminal.

generating a fifth instruction response according to the fingerprint verifying result of the card in Step 106 specifically is: generating, by the card, a fifth instruction response according to the card verifying result and the transaction refusing flag.

the card obtains a card verifying result according to the fingerprint verifying result in Step 106 specifically is that the card obtains a card verifying result according to the fingerprint verifying result and a result of determining whether fingerprint retry times surpasses limit.

Step 101 further includes: when the instruction is a first instruction comprising an application identifier of a specified application, the card returns a first instruction response comprising a specified application list.

Step 101 further includes: when the instruction is a second instruction including application identification of selecting application, the card returns a second instruction response including a Processing Options Data Object List.

That the card verifies fingerprint of a user, obtains a fingerprint verifying result in Step 102 specifically is: the card sends a waiting time extending instruction to the terminal at a preset time interval, verifies fingerprint of a user, stop to send the waiting time extending instruction to the terminal after the card obtaining a fingerprint verifying result.

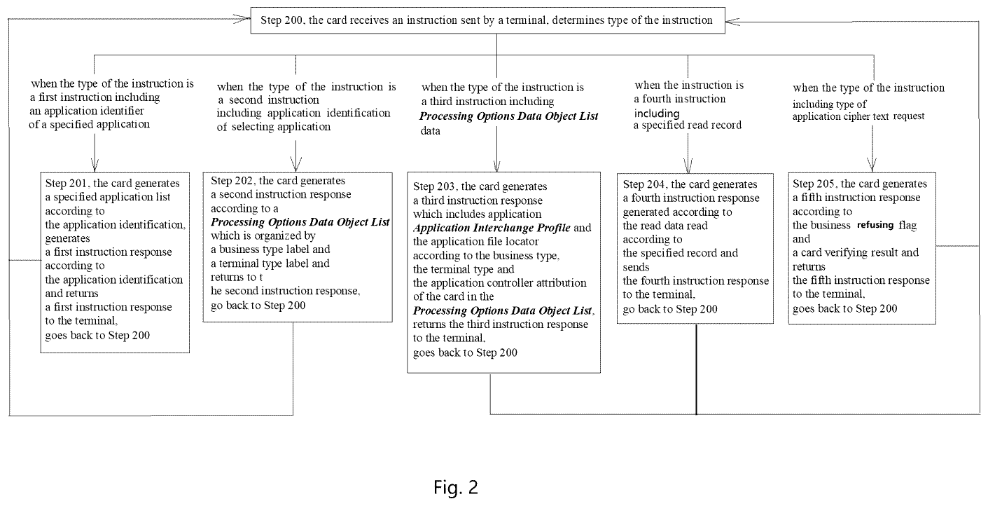

Another implementation method of the fingerprint card according to the present invention, as shown in FIG. 2, specifically includes the following steps:
Step 200, the card receives an instruction sent by a terminal, determines type of the instruction. when the type of the instruction is a first instruction including an application identifier of a specified application, executing Step 201; when the type of the instruction is a second instruction including application identification of selecting application, executing Step 202; when the type of the instruction is a third instruction including Processing Options Data Object List data, executing Step 203; when the instruction is a fourth instruction including a specified read record, executing Step 204; when the type of the instruction including an application cryptogram request type, executing Step 205;
Step 201, the card generates a specified application list according to the application identification, generates a first instruction response according to the application identification and returns a first instruction response to the terminal, goes back to Step 200.

In the present embodiment, the first instruction received by the card from the terminal is: 00A404000E 325041592E5359532 E4444463031.

Specifically, in the above instruction, 325041592E5359532E4444463031 specifies an identification of a specified application to be accessed, i.e., application of Proximity Payment Systems Environment (PPSE);

The card organizes a first instruction response according to a label of application identification of a specified application of the card, length of the application identification and the application identification.

Specifically, the first instruction response is:
6F23840E325041592E5359532E4444463031A511BFOC0E61 0C4F08 A000000151041010;
in this case, in the response data, data element 4F is label of the application identification, the value of the application identification is: A000000151 041010, specifically, A000000151041010 is the application identification of a specified application.

Step 202, the card generates a second instruction response according to a Processing Options Data Object List which is organized by a transaction type label and a terminal type label and returns to the second instruction response, go back to Step 200.

Specifically, in the present embodiment, the second instruction received by the card from the terminal is: 00A4040008 A000000151 041010; in this case, the application identification of the application selected by the terminal is: A000000151041010.

The card generates a second instruction response according to a Processing Options Data Object List which is organized according to attached terminal performance label and its specified length, label of transaction type and its specified length, label of terminal type and its specified length.

Specifically, the second instruction response of the card is:
6F3D8408A000000151041010A531500A4D6173746572436172649F38089F40059C019F350 1BFOC179F5E095413339000001513019F5D030101009F4D020BOA;
in this case, Processing Options Data Object List is: 9F3808 9F4005 9C01 9F3501,
9F38 represents label of Processing Options Data Object List, its specified length is 8 bytes;
9F40 represents its attached terminal performance label, its specified length is 5 bytes;
9C represents transaction type label, its specified length is 1 byte;
9F35 represents terminal type label, its specified length is 1 byte.

Specifically, the attached terminal performance label, the transaction type label, the terminal type label in the Processing Options Data Object List respectively represent the attached terminal performance, the transaction type and the terminal type which are wanted by the card.

Step 203, the card generates a third instruction response which includes Application Interchange Profile and the application file locator according to the transaction type, the terminal type and the application controller attribution of the card in the Processing Options Data Object List, returns the third instruction response to the terminal, goes back to Step 200.

The third instruction received by the card from the terminal specifically is: 80A8000009 8307 1111000000 00 22, the domain of the third instruction is data requested by the Processing Options Data Object List of the second instruction response.

Specifically, the value of the attached terminal performance is: 1111000000;
the transaction type is: 00;
9F35 represents that terminal type is 22.

Specifically, the third instruction response includes Application Interchange Profile and application file locator.

Specifically, process of generating a third instruction response in Step 203 includes the following step:
the card determines an attribution of the application controller:
specifically, in the present step, the card determines value from the fifth bit to the seventh bit of the second byte of the application controller:
when the attribution of the application controller is: “not supporting fingerprint verifying”, the card returns obtaining processing option default response data.

Specifically, when the card determines that value from the fifth bit to the seventh bit of the second byte of the application controller is: 000 or 110 or 111, the card returns the third instruction response which the obtaining processing option default response data.

When the attribution of the application controller is: for any terminal, refusing transaction if fingerprint verifying is not successful, the following step is executed:

Specifically, when the card determines that the value of from the second byte to the fifth byte of the application controller is 011, following step is executed:

Step a1, the card verifies fingerprint input by a user, obtains a fingerprint verifying result and stores the fingerprint verifying result.

Step a1 specifically can be that the card sends a waiting time extending instruction to the terminal at a preset time interval and verifies fingerprint of a user at the same time, stops to send the waiting time extending instruction to the terminal after the card obtains and stores a fingerprint verifying result.

Step a2, the card determines whether the fingerprint verifying result is that fingerprint verifying is successful, if yes, executes Step a3, if no, sets a transaction refusing flag, executes Step a4.

Specifically, in the present step, the card determines value of byte in the data of the obtained fingerprint verifying result, if the value is 01, executes Step a3; if the value is 00 or 02, sets the transaction refusing flag, executes Step a4;
in this case, if the value of byte in the data of the obtained fingerprint verifying result is 01, it represents that fingerprint verifying is successful: if the value of byte in the data of the obtained fingerprint verifying result is 00, it represents that fingerprint verifying is not executed; if the value of byte in the data of the obtained fingerprint verifying result is 02, it represents that fingerprint verifying is failed.

Step a3, the card determines whether the transaction type is a specified transaction type, if yes, executes Step a4; if no, execute Step a5;

Specifically, in the present embodiment, the card determines whether the value of data of 9C which represents transaction type in the data of the Processing Options Data Object List is 01, 09 or 17, if yes, executes Step a4, if no, executes Step a5.

Step a4, the card returns a third instruction response which is obtaining processing option default response data.

Specifically, in the present Step a4, the third instruction response returned by the card is as the following:
the application interchange profile (AIP) is 7900;
the application file locator (AFL) is 08010100100104011801050020010301, in which 08010100 10010401 18010500 20010301 represent location to be read records and number of pieces to be read record.

Step a5, the card returns a third instruction response which is obtaining processing option fingerprint response data.

Specifically, in the present step, the card returns a third instruction response which is 771682026900941008010100100104 011801050020010301;

In this case, the Application Interchange Profile (AIP) is: 6900;
the application file locator (AFL) is 08010100100104011801050020010301, in which 08010100 100104 01 18010500 20010301 represent location to be read records and number of pieces to be read record. When the application controller attribution is: not refusing transaction if the fingerprint verifying is not successful, following steps are executed:

Specifically, when the card determines that value from the second bit to the fifth bit of the second byte of the application controller is: 001 or 010, the following steps are executed:

Step b1, the card verifies the fingerprint input by a user and obtains a fingerprint verifying result, stores the fingerprint verifying result.

Step b1 specifically can be that: the card sends a waiting time extending instruction to the terminal at a preset time interval and verifies fingerprint of a user at the same time, stops to send the waiting time extending instruction to the terminal after the card obtains a fingerprint verifying result and stores the fingerprint verifying result.

Step b2, the card determines whether the fingerprint verifying result is that fingerprint verifying is successful, if yes, executes Step b3; if no, executes Step b4;

Specifically, in the present step b2, the card determines value of the byte in the obtained fingerprint verifying result data, if the value is 01, executes Step b3, if the value is 00 or 02, execute Step b4;
in this case, if the value of byte in the data of the obtained fingerprint verifying result is 01, it represents that fingerprint verifying is successful: if the value of byte in the data of the obtained fingerprint verifying result is 00, it represents that fingerprint verifying is not executed: if the value of byte in the data of the obtained fingerprint verifying result is 02, it represents that fingerprint verifying is failed.

Step b3, the card determines whether the transaction type is a specified transaction type, if yes, executes Step b4, if no, executes Step b5.

Specifically, in the present embodiment, the card determines whether the value of data of 9C which represents transaction type in the data of the Processing Options Data Object List is 01, 09 or 17, if yes, executes Step b4, if no, executes Step b5. Step b4, the card returns a third instruction response which is obtaining processing option default response data.

Specifically, in the present step b4, the card returns a third instruction response, of which
the application interchange profile (AIP) is 7900;
the application file locator (AFL) is 08010100100104011801050020010301;
in this case, 08010100 10010401 18010500 20010301 represent location to be read records and number of pieces to be read record.

Step b5, the card returns a third instruction response which is obtaining processing option fingerprint response data.

Specifically, in the present step b5, the card returns a third instruction response which is 771682026900941008010100100104 011801050020010301;
in this case, the application interchange profile is: 6900;
the application file locator (AFL) is 08010100100104011801050020010301, of which 08010100 100104 01 18010500 20010301 represent location to be read records and number of pieces to be read record.

When the application controller attribution is: for any terminal which is not a specified terminal, refusing transaction if the fingerprint is not successful, the following steps are executed:

Specifically, in the present step b5, when the card determines that value from the fifth bit to the seventh bit of the second byte of the application controller is 100 or 101,

Step c0, the card determines whether the type of terminal is a specified type of terminal, if yes, executes Step c4; if no, executes Step c1.

Specifically; in the present step, the card determines whether the value of 9F35 which represents terminal type in the data of the Processing Options Data Object List is 14, 15 or 16 and the eighth bit of the first byte of the data corresponding to 9F40 which represents attached terminal performance is 1. if yes, execute Step c4, if no, execute Step c1.

Step c1, the card verifies fingerprint input by the user and obtains a fingerprint verifying result and stores the fingerprint verifying result:

Step c1, specifically can be that the card sends a waiting time extending instruction to the terminal at a preset time interval and verifies fingerprint of a user at the same time, stops to send the waiting time extending instruction to the terminal after the card obtains and stores a fingerprint verifying result.

Step c2, the card determines whether the fingerprint verifying result is that fingerprint verifying is successful, if yes, executes Step c3, if no, sets a transaction refusing flag, executes Step c4;

Specifically, the card determines value of byte of the obtained fingerprint verifying result, if the value is 01, executes Step c3, if the value is 00 or 02, executes Step c4;
in this case, if the value of byte in the data of the obtained fingerprint verifying result is 01, it represents that fingerprint verifying is successful; if the value of byte in the data of the obtained fingerprint verifying result is 00, it represents that fingerprint verifying is not executed; if the value of byte in the data of the obtained fingerprint verifying result is 02, it represents that the fingerprint verifying is failed.

Step c3, the card determines whether the transaction type is a specified transaction type, if yes, executes Step c4; if no, execute Step c5.

Specifically, in the present embodiment, the card determines whether the value of data of 9C which represents transaction type in the data of the Processing Options Data Object List is 01, 09 or 17. if yes, executes Step c4, if no, executes Step c5.

Step c4, the card returns a third instruction response which is obtaining processing option default response data.

Specifically, in the present Step c4, the third instruction response returned by the card is as the following:
the application interchange profile (AIP) is 7900;
the application file locator (AFL) is 08010100100104011801050020010301, in which
08010100 10010401 18010500 20010301 represents location to be read records and number of pieces to be read record.

Step c5, the card returns a third instruction response which is obtaining processing option fingerprint response data.

Specifically, in the present step, the card returns a third instruction response which is 771682026900941008010100100104 011801050020010301;
in this case, the Application Interchange Profile (AIP) is: 6900;
the application file locator (AFL) is 08010100100104011801050020010301, in which 08010100 100104 01 18010500 20010301 represents location to be read records and number of pieces to be read record.

Step 204, the card generates a fourth instruction response generated according to the read data read according to the specified record and sends the fourth instruction response to the terminal, go back to Step 200.

Specifically, the card receives a fourth instruction, i.e., a read instruction, sent from the terminal, the read instruction includes a file of a specified record to be read.

Specifically, in the present step 204, that the card generates a fourth instruction response according to specified read record specifically is that the card read data according to a specified read record in the read instruction, generates a fourth instruction response according to the data read according to the specified read record.

Specifically, the card generates a fourth instruction response wherein the specified read record includes a Card Risk Management Data Object List.

Step 205, the card generates a fifth instruction response according to the transaction refusing flag and a card verifying result and returns the fifth instruction response to the terminal, then goes back to Step 200.

Specifically, the fifth instruction is an application cipher text instruction sent by the terminal to the card, of which the domain of the application cipher text instruction is generated according to the Card Risk Management Data Object List.

Specifically, the cipher text instruction is 80AE4000420000000000010000000000000156000000000001562003310037151A5F22000000000 000000000003F00001131481111111111111111111111111111111111111111.

The domain data of the application ciphertext instruction is parsed as the following: 9F02 represents authorized amount: 000000000001; 9F03 represents other amount: 000000000000; 9F1A represents terminal code 0156; 95 represents terminal verifying result: 0000000000; 5F2A represents transaction code: 0156; 9A represents date 200331; 9C represents transaction type: 00; 9F37 represents random number: 37151A5F; 9F35 represents terminal type: 22; 9F45 represents verification code of data: 0000; 9F4C represents ICC dynamic data: 0000000000000000; 9F34 represents card holder verifying method: 3F0000: 9F21 represents transaction time: 113148: 9F7C represents merchant custom data: 111111111 11111111111 1111111111 1111.

Specifically, in the present step, the card generates a fifth instruction response data: 77319F2701409F360200019F2608C6E63C7578CD0A909F101A22109102032400010000000 00000000001FF00000000000000FF.

In this case, the card verifying result is 910203240001.

Specifically, in the present step, that the card generates a fifth instruction response specifically includes the following steps:

Step B1, the card generates a card verifying result.

Step B1 specifically is that the card sets value of byte in the card verifying result according to the fingerprint verifying result, which specifically includes the following steps:

Step d1, the card sets the value of the card verifying result according to the fingerprint verifying result and executing status of fingerprint verifying.

Specifically, the card sets the value of the first bit of the first byte of the card verifying result according to the card verifying result which represents success or failure and sets the value of the second bit of the card verifying result which represents whether executing or not.

Specifically, if the fingerprint verifying result is success, the value of the first bit of the first byte of the card verifying result is set to be 1; if the fingerprint verifying result is failure, the first bit of the first byte of the card verifying result is set to be 0; if the fingerprint verifying is executed, the value of the second bit of the second byte of the card verifying result is set to be 1; if the fingerprint verifying is not executed, the value of the second bit of the second byte of the card verifying result is set to be 0).

Step d2, the card sets value of the card verifying result according to a result obtained by determining whether fingerprint retry times surpasses limit or not.

Specifically, in the present step d2, the card sets the value of the first bit of the second byte of the card verifying result according to the a result that whether fingerprint retry times surpasses limit or not, if the card determines that the fingerprint retry times surpasses limit, the card sets the value of the first bit of the second byte of the card verifying result to be 1; if the card determines that the fingerprint retry times does not surpass limit, the card sets the value of the first bit of the second byte of the card verifying result to be 0.

Step B2, the card executes card behavior parsing and card risk managing to obtain a card behavior parsing result and a card risk managing result.

Step B3, the card generates an application cipher text instruction response according to the card behavior parsing result, a card risk managing result, cipher text request type in an application ciphertext instruction sent by the terminal, the transaction refusing flag of the card and the card verifying result.

The generated application cipher text instruction response can be an application cipher text response of refusing transaction, an application cipher text response of online transaction or an application cipher text response of offline transaction.

Specifically, in the present step B3, when the card determines that the transaction refusing flag is refusing flag, the card returns an application cipher text response of refusing transaction.

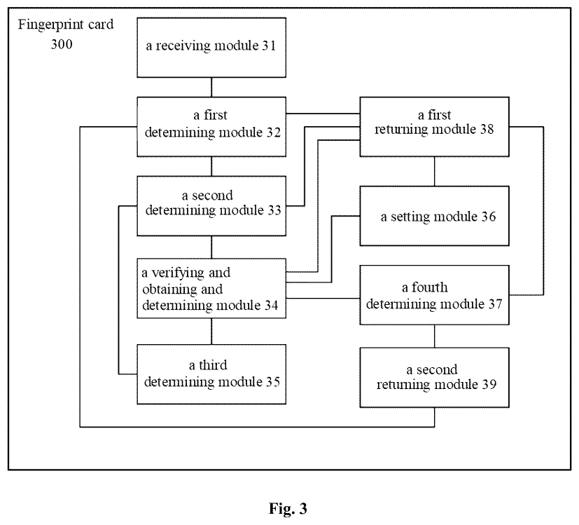

A fingerprint card 300 according to the present invention, as shown in FIG. 3, includes:
a receiving module 31 configured to receive an instruction sent from a terminal;
a first determining module 32 configured to determine type of the instruction received by the receiving module 31;
a second determining module 33 configured to determine value of application controller attribution of the card when the first determining module 32 determines that type of the instruction; when the instruction is a third instruction comprising Processing Options Data Object List data;
a verifying and obtaining and determining module 34 configured to verify fingerprint of a user, obtain a fingerprint verifying result and determine whether the fingerprint verifying result is that fingerprint verifying is successful when the second determining module 33 determines that the value of application controller attribution of the card is a first preset value;
the verifying and obtaining and determining module 34 further configured to verify fingerprint of a user, obtain a fingerprint verifying result and determine whether the fingerprint verifying result is that fingerprint verifying is successful when the second determining module 33 determines that the value of application controller attribution of the card is a second preset value;
the verifying and obtaining and determining module 34 further configured to verify fingerprint of a user, obtain a fingerprint verifying result and determine whether the fingerprint verifying result is that fingerprint verifying is successful when a third determining module 35 determines that type of the terminal is a specified terminal type;
the third determining module 35 configured to determine whether type of the terminal is a specified terminal type when the second determining module 33 determines that the value of the application controller attribution is a third preset value;
a setting module 36 configured to set transaction refusing flag when the second determining module 33 determines that the value of the application controller attribution is the first preset value and the verifying and obtaining and determining module 34 determines that the fingerprint verifying result is not that fingerprint verifying is successful;
the setting module 36 further configured to set transaction refusing flag when the third determining module 35 determines that the type of the terminal is not a specified terminal type and the verifying and obtaining and determining module 34 determines that the fingerprint verifying result is not that fingerprint verifying is successful;
a fourth determining module 37 configured to determine whether transaction type in the Processing Options Data Object List data is a specified type of transaction when the verifying and obtaining and determining module 34 determines that the fingerprint verifying result is that fingerprint verifying is successful;
a first returning module 38 configured to, after the setting module sets the transaction refusing flag, return a third instruction response of default type comprising a first Application Interchange Profile and a first application file locator to the terminal;
the first returning module 38 further configured to, when the fourth determining module 37 determines that transaction type in the Processing Options Data Object List data is specified type of transaction, return a third instruction response of fingerprint type comprising a second Application Interchange Profile and a second application file locator to the terminal;
the first returning module 38 further configured to return a third instruction response of default type comprising a first Application Interchange Profile and a first application file locator to the terminal when the second determining module 33 determines that the value of application controller attribution of the card is a second preset value and the verifying and obtaining and determining module 34 determines that the fingerprint verifying result is not that fingerprint verifying is successful; further configured to return a reading record specified by the first application file locator to the terminal when the first determining module 32 determines that the type of the instruction is a fourth instruction generated according to a first application file locator; and
a second returning module 39 configured to return a third instruction response of fingerprint type comprising a second Application Interchange Profile and a second application file locator to the terminal when the fourth determining module 37 determines that the transaction type in the Processing Options Data Object List data is not specified transaction type; further configured to return a reading record specified by the second application file locator to the terminal when the first determining module 32 determines that the type of the instruction is a fourth instruction generated according to the second application file locator.

In the fingerprint card 300, the second determining module 33 determines that the value of application controller attribution of the card is a first preset value specifically is that: the second determining module 33 determines that the application controller attribution of the card is: for any terminal. refuse transaction if fingerprint verifying is not successful;
that the second determining module 33 determines that the value of application controller attribution of the card is a second preset value specifically is that: the second determining module 33 determines that the application controller attribution of the card is: do not refuse transaction if the fingerprint is not successful; and
that the second determining module 33 determines that the value of application controller attribution of the card is a third preset value specifically is that: the second determining module 33 determines that the application controller attribution of the card is: for any terminal which is not a specified terminal, refuse transaction if the fingerprint is not successful.

The first returning module 38 is further configured to a third instruction response of default type comprising a first Application Interchange Profile and a first application file locator to the terminal when the second determining module 33 determines that the value of application controller attribution of the card is a fourth preset value.

The second determining module 33 determines that the value of application controller attribution of the card is a fourth preset value specifically is that: the second module determines that application controller attribution of the card is: do not support fingerprint verifying.

The fingerprint card further comprises: an obtaining and generating and returning module configured to, when the first determining module 32 determines that the instruction is a fifth instruction comprising an application cryptogram request type, a card verifying result according to the fingerprint verifying result, generate a fifth instruction response according to the card verifying result and return the fifth instruction to the terminal.

The obtaining and generating and returning module specifically is configured to, when the first determining module 32 determines that the instruction is a fifth instruction comprising application cryptogram request type, obtain a card verifying result according to the fingerprint verifying result, generate a fifth instruction response according to the card verifying result and the transaction refusing flag. return the fifth instruction response to the terminal.

The obtaining and generating and returning module specifically is configured to, when the first determining module 32 determines that the instruction is a fifth instruction comprising application cryptogram request type, obtain a card verifying result according to the fingerprint verifying result and a result of determining whether fingerprint retry times surpass limit, generate a fifth instruction response according to the card verifying result and the transaction refusing flag, return the fifth instruction response to the terminal.

The fingerprint card further includes a third returning module, configured to, when the first determining module 32 determines that the instruction comprising an application identifier of a specified application, return a first instruction response comprising a specified application list.

The fingerprint card further comprises a fourth returning module configured to, when the first determining module 32 determines that the instruction is a second instruction comprising an application identifier of selecting application, return a second instruction response comprising a Processing Options Data Object List.

The verifying and obtaining and determining module 34 is configured to verify fingerprint of the user, obtain a fingerprint verifying result specifically is: the verifying and obtaining and determining module 34 configured to send a waiting time extending instruction to the terminal at a preset time interval, verify fingerprint of a user, stop to send the waiting time extending instruction to the terminal after the card obtaining a fingerprint verifying result.

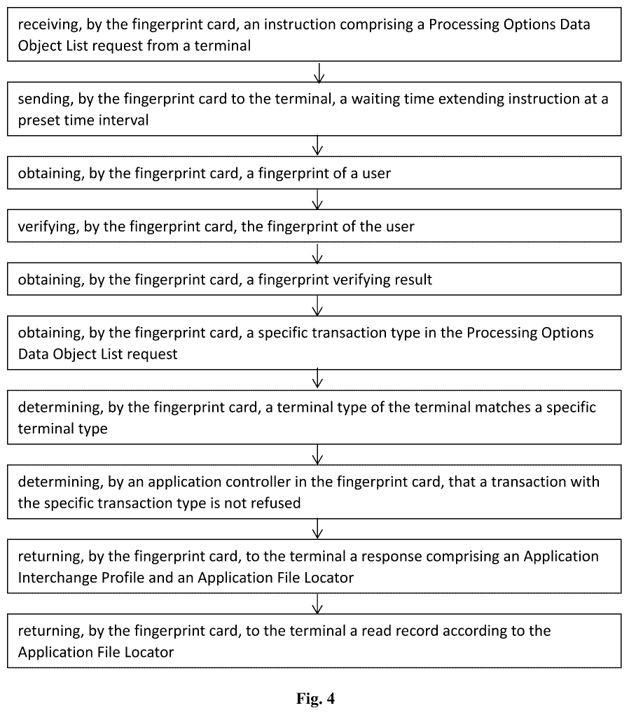

In summary, as shown in FIG. 4, the transaction communication method of the fingerprint card according to the present invention can be summarized as follows:
receiving, by the fingerprint card, an instruction comprising a Processing Options Data Object List request from a terminal;
sending, by the fingerprint card, to the terminal a waiting time extending instruction at a preset time interval;
obtaining, by the fingerprint card, a fingerprint of a user;
verifying, by the fingerprint card, the fingerprint of the user;
obtaining, by the fingerprint card, a fingerprint verifying result;
obtaining, by the fingerprint card, a specific transaction type in the Processing Options Data Object List request;
determining, by the fingerprint card, that a terminal type of the terminal matches a specific terminal type;
determining, by an application controller in the fingerprint card, that a transaction with the specific transaction type is not refused;
returning, by the fingerprint card, to the terminal a response comprising an Application Interchange Profile and an Application File Locator; and
returning, by the fingerprint card, to the terminal a read record according to the Application File Locator.

In summary, on the other hand, the fingerprint card according to the present invention includes a processor, input/output devices coupled to the processor, and memory that communicates with the processor. The memory stores instructions that are configured to cause the processor to perform the following steps:
receiving, by the fingerprint card, an instruction comprising a Processing Options Data Object List request from a terminal;
sending, by the fingerprint card, to the terminal a waiting time extending instruction at a preset time interval;
obtaining, by the fingerprint card, a fingerprint of a user; verifying, by the fingerprint card, the fingerprint of the user; obtaining, by the fingerprint card, a fingerprint verifying result;
obtaining, by the fingerprint card, a specific transaction type in the Processing Options Data Object List request;
determining, by the fingerprint card, a terminal type of the terminal matches a specific terminal type;
determining, by an application controller in the fingerprint card, that a transaction with the specific transaction type is not refused;
returning, by the fingerprint card, to the terminal a response comprising an Application Interchange Profile and an Application File Locator; and returning, by the fingerprint card, to the terminal a read record according to the Application File Locator.

The non-transitory computer-readable storage medium according to the present invention stores instructions to execute on a fingerprint card to carry out the method of the present invention.

The embodiments of the invention will be further described in details as below. Examples of the embodiments are shown in drawings. Apparently, the disclosures are only a few specific embodiments of the application, but the application is not limited to them, and any changes that can be thought of by those skilled in the art should fall into the protection scope of the application. The scope of protection of the application is approved by the appended claims.

What is claimed is:

1. A method for communicating with a fingerprint card to perform transaction, comprising:
receiving, by the fingerprint card, an instruction comprising a Processing Options Data Object List request from a terminal;
sending, by the fingerprint card, to the terminal a waiting time extending instruction at a preset time interval;
obtaining, by the fingerprint card, a fingerprint of a user;
verifying, by the fingerprint card, the fingerprint of the user;
obtaining, by the fingerprint card, a fingerprint verifying result;
obtaining, by the fingerprint card, a specific transaction type in the Processing Options Data Object List request;
determining, by the fingerprint card, that a terminal type of the terminal matches a specific terminal type;
determining, by an application controller in the fingerprint card, that a transaction with the specific transaction type is not refused;
returning, by the fingerprint card, to the terminal a response comprising an Application Interchange Profile and an Application File Locator; and
returning, by the fingerprint card, to the terminal a read record according to the Application File Locator.

2. The method of claim 1, wherein obtaining, by the fingerprint card, the fingerprint verifying result; then stopping, by the fingerprint card, sending the waiting time extending instruction to the terminal.

3. The method of claim 1, wherein the transaction is not refused by the application controller in the fingerprint card, according to the fingerprint verifying result, the specific transaction type and the specific terminal type.

4. The method of claim 1, wherein the transaction is refused or not refused by the application controller in the fingerprint card, based on one of the following rules stored in the fingerprint card:
for any terminal, refusing any transaction if a fingerprint verifying result is not successful;
for a terminal with the specific terminal type, not refusing a transaction if a fingerprint verifying result is not successful; and
for any terminal without the specific terminal type, refusing the transaction if the fingerprint verifying result is not successful.

5. The method of claim 4, wherein the method further comprises:
setting, by the fingerprint card, a transaction refusal flag according to the rules stored in the fingerprint card.

6. The method of claim 1, wherein obtaining, by the fingerprint card, the fingerprint verifying result comprises:
determining, by the fingerprint card, whether a value of fingerprint obtaining retry times exceeds a preset count limit.

7. A fingerprint card, comprising:
a processor;
an input/output device coupled to the processor; and
a memory in communication with the processor, in which the memory stores instructions, configured to cause the processor to:
receive an instruction comprising a Processing Options Data Object List request from a terminal;
send to the terminal a waiting time extending instruction at a preset time interval;
obtain a fingerprint of a user;
verify the fingerprint of the user;
obtain a fingerprint verifying result;
obtain a specific transaction type in the Processing Options Data Object List request;
determine that a terminal type of the terminal matches a specific terminal type;
determine, by an application controller in the fingerprint card, that a transaction with the specific transaction type is not refused;
return to the terminal a response comprising an Application Interchange Profile and an Application File Locator; and
return to the terminal a read record according to the Application File Locator.

8. The fingerprint card of claim 7, wherein obtaining the fingerprint verifying result; then stopping, by the fingerprint card, sending the waiting time extending instruction to the terminal.

9. The fingerprint card of claim 7, wherein the transaction is not refused by the application controller in the fingerprint card, according to the fingerprint verifying result, the specific transaction type and the specific terminal type.

10. The fingerprint card of claim 7, wherein the transaction is refused or not refused by the application controller in the fingerprint card, based on one of the following rules stored in the fingerprint card:
for any terminal, refusing any transaction if a fingerprint verifying result is not successful;
for a terminal with the specific terminal type, not refusing a transaction if a fingerprint verifying result is not successful; and
for any terminal without the specific terminal type, refusing the transaction if the fingerprint verifying result is not successful.

11. The fingerprint card of claim 10, wherein the processor is further caused to:
set, by the fingerprint card, a transaction refusal flag according to the rules stored in the fingerprint card.

12. The fingerprint card of claim 7, wherein to obtain the fingerprint verifying result comprises:
determine, by the fingerprint card, whether a value of fingerprint obtaining retry times exceeds a preset count limit.

13. A non-transitory computer readable storage medium, wherein the non-transitory computer readable storage medium stores instructions to:
receive, by the fingerprint card, an instruction comprising a Processing Options Data Object List request from a terminal;
send, by the fingerprint card, to the terminal a waiting time extending instruction at a preset time interval;
obtain, by the fingerprint card, a fingerprint of a user;
verify, by the fingerprint card, the fingerprint of the user;
obtain, by the fingerprint card, a fingerprint verifying result;
obtain, by the fingerprint card, a specific transaction type in the Processing Options Data Object List request;
determine, by the fingerprint card, that a terminal type of the terminal matches a specific terminal type;
determine, by an application controller in the fingerprint card, that a transaction with the specific transaction type is not refused;
return, by the fingerprint card, to the terminal a response comprising an Application Interchange Profile and an Application File Locator; and
return, by the fingerprint card, to the terminal a read record according to the Application File Locator.

14. The non-transitory computer readable storage medium of claim 13, wherein obtaining the fingerprint verifying result; then stopping, by the fingerprint card, sending the waiting time extending instruction to the terminal.

15. The non-transitory computer readable storage medium of claim 13, wherein the transaction is not refused by the application controller in the fingerprint card, according to the fingerprint verifying result, the specific transaction type and the specific terminal type.

16. The non-transitory computer readable storage medium of claim 13, wherein the transaction is refused or not refused by the application controller in the fingerprint card, based on one of the following rules stored in the fingerprint card:
for any terminal, refusing any transaction if a fingerprint verifying result is not successful;
for a terminal with the specific terminal type, not refusing a transaction if a fingerprint verifying result is not successful; and
for any terminal without the specific terminal type, refusing the transaction if the fingerprint verifying result is not successful.

17. The non-transitory computer readable storage medium of claim 16, wherein the non-transitory computer readable storage medium further stores instructions to:
set, by the fingerprint card, a transaction refusal flag according to the rules stored in the fingerprint card.

18. The non-transitory computer readable storage medium of claim 13, wherein to obtain, by the fingerprint card, the fingerprint verifying result comprises:
determine, by the fingerprint card, whether a value of fingerprint obtaining retry times exceeds a preset count limit.
